(19) United States
(12) Patent Application Publication
(10) Pub. No.: US 2025/0103521 A1
(43) Pub. Date: Mar. 27, 2025

(54) SYSTEM-ON-CHIP DRIVEN BY CLOCK SIGNALS HAVING DIFFERENT FREQUENCIES

(71) Applicant: SK hynix Inc., Gyeonggi-do (KR)

(72) Inventor: Jae Min HYUN, Gyeonggi-do (KR)

(21) Appl. No.: 18/436,026

(22) Filed: Feb. 8, 2024

(30) Foreign Application Priority Data
Sep. 25, 2023 (KR) 10-2023-0128065

(51) Int. Cl. G06F 13/16; G06F 1/08; G06F 13/42

(52) U.S. Cl. CPC G06F 13/1689; G06F 1/08; G06F 13/1615; G06F 13/4273

(57) ABSTRACT

A system-on-chip includes plural components, configured to perform separate functions, separate calculations, or separate operations, and a bus interface configured to support data communication between the plural components according to a point-to-point interconnect protocol. At least one component of the plural components is operatively engaged with a memory device. The at least one component includes: plural memory interfaces configured to access the memory device in an n-way interleaving way, where n is a positive integer which is equal to or greater than 2; and at least one slave intellectual property (IP) core configured to distribute and transmit, to the plural memory interfaces, plural commands input through the bus interface.

### CROSS-REFERENCE TO RELATED APPLICATIONS

This patent application claims the benefit of priority under 35 U.S.C. § 119 (a) to Korean Patent Application No. 10-2023-0128065, filed on Sep. 25, 2023, the entire disclosure of which is incorporated herein by reference.

### TECHNICAL FIELD

One or more embodiments of the present disclosure described herein relate to a system-on-chip, and more particularly, to an apparatus for performing data input/output and data transfer based on clock signals having different frequencies in the system-on-chip including a memory device.

### BACKGROUND

A system-on-Chip (SoC) is an integrated circuit (IC) that combines multiple electronic components or subsystems, such as processors, memories, I/O controllers, and special function blocks/circuits, on a single chip. These components or subsystems are implemented as an intellectual property (IP) core that can be licensed or independently developed. The system-on-a-chip (SoC) can be designed to perform most or all functions of an electronic system in a compact, energy-efficient, and cost-effective manner. For example, the system-on-chips (SoC) are widely used in a variety of applications such as smartphones, tablets, embedded systems, automotive electronics, and Internet of Things (IoT) devices.

A data processing system including a memory system or a data storage device can store more amounts of data in the data storage device and store data in the data storage device more quickly. The memory system has been developed to output data stored in the data storage device more quickly. The data storage device may include non-volatile memory cells and/or volatile memory cells for storing data.

### BRIEF DESCRIPTION OF THE DRAWINGS

The description herein makes reference to the accompanying drawings wherein like reference numerals refer to like parts throughout the figures.

FIG. 1 illustrates a system-on-chip (SoC) according to an embodiment of the present disclosure.

FIG. 2 illustrates another system-on-chip (SoC) according to another embodiment of the present disclosure.

FIG. 3 illustrates a memory subsystem according to an embodiment of the present disclosure.

FIG. 4 shows a first internal configuration of the memory subsystem described in FIG. 3.

FIG. 5 shows a second internal configuration of the memory subsystem described in FIG. 3.

FIG. 6 shows a third internal configuration of the memory subsystem described in FIG. 3.

FIG. 7 shows a fourth internal configuration of the memory subsystem described in FIG. 3.

FIG. 8 shows a fifth internal configuration of the memory subsystem described in FIG. 3.

FIG. 9 shows a sixth internal configuration of the memory subsystem described in FIG. 3.

FIG. 10 describes a planar size of the memory subsystem according to an embodiment of the present disclosure.

FIG. 11 shows a seventh internal configuration of the memory subsystem described in FIG. 3.

FIG. 12 illustrates a memory system according to an embodiment of the present disclosure.

FIG. 13 illustrates a memory system according to another embodiment of the present disclosure.

### DETAILED DESCRIPTION

Various embodiments of the present disclosure are described below with reference to the accompanying drawings. Elements and features of this disclosure, however, may be configured or arranged differently to form other embodiments, which may be variations of any of the disclosed embodiments.

In this disclosure, references to various features (e.g., elements, structures, modules, components, steps, operations, characteristics, etc.) included in “one embodiment,” “example embodiment,” “an embodiment,” “another embodiment,” “some embodiments,” “various embodiments,” “other embodiments,” “alternative embodiment,” and the like are intended to mean that any such features are included in one or more embodiments of the present disclosure, but may or may not necessarily be combined in the same embodiments.

In this disclosure, the terms “comprise,” “comprising,” “include,” and “including” are open-ended. As used in the appended claims, these terms specify the presence of the stated elements and do not preclude the presence or addition of one or more other elements. The terms in a claim do not foreclose the apparatus from including additional components e.g., an interface unit, circuitry, etc.

In this disclosure, various units, circuits, or other components may be described or claimed as “configured to” perform a task or tasks. In such contexts, “configured to” is used to connote structure by indicating that the blocks/units/circuits/components include structure (e.g., circuitry) that performs one or more tasks during operation. As such, the block/unit/circuit/component can be said to be configured to perform the task even when the specified block/unit/circuit/component is not currently operational, e.g., is not turned on nor activated. Examples of block/unit/circuit/component used with the “configured to” language include hardware, circuits, memory storing program instructions executable to implement the operation, etc. Additionally, “configured to” can include a generic structure, e.g., generic circuitry, that is manipulated by software and/or firmware, e.g., an FPGA or a general-purpose processor executing software to operate in a manner that is capable of performing the task(s) at issue. “Configured to” may also include adapting a manufacturing process, e.g., a semiconductor fabrication facility, to fabricate devices, e.g., integrated circuits that are adapted to implement or perform one or more tasks.

As used in this disclosure, the term ‘machine,’ ‘circuitry’ or ‘logic’ refers to all of the following: (a) hardware-only circuit implementations such as implementations in only analog and/or digital circuitry and (b) combinations of circuits and software and/or firmware, such as (as applicable): (i) to a combination of processor(s) or (ii) to portions of processor(s)/software including digital signal processor(s), software, and memory (ies) that work together to cause an apparatus, such as a mobile phone or server, to perform various functions and (c) circuits, such as a microprocessor(s) or a portion of a microprocessor(s), that require software or firmware for operation, even if the software or firmware is not physically present. This definition of ‘machine,’ ‘circuitry’ or ‘logic’ applies to all uses of this term in this application, including in any claims. As a further example, as used in this application, the term ‘machine,’ ‘circuitry’ or ‘logic’ also covers an implementation of merely a processor or multiple processors or a portion of a processor and its (or their) accompanying software and/or firmware. The term ‘machine,’ ‘circuitry’ or ‘logic’ also covers, for example, and if applicable to a particular claim element, an integrated circuit for a storage device.

As used herein, the terms ‘first,’ ‘second,’ ‘third,’ and so on are used as labels for nouns that they precede, and do not imply any type of ordering, e.g., spatial, temporal, logical, etc. The terms ‘first’ and ‘second’ do not necessarily imply that the first value must be written before the second value. Further, although the terms may be used herein to identify various elements, these elements are not limited by these terms. These terms are used to distinguish one element from another element that otherwise have the same or similar names. For example, a first circuitry may be distinguished from a second circuitry.

Further, the term ‘based on’ is used to describe one or more factors that affect a determination. This term does not foreclose additional factors that may affect a determination. That is, a determination may be solely based on those factors or based, at least in part, on those factors. Consider the phrase “determine A based on B.” While in this case, B is a factor that affects the determination of A, such a phrase does not foreclose the determination of A from also being based on C. In other instances, A may be determined based solely on B.

Embodiments of the present disclosure may provide an apparatus and a method that can support data input/output performance of a memory device to correspond to an operating speed of a system-on-chip (SoC) through an interleaving way or scheme in which a component included in the system-on-chip (SoC), the memory device, and a circuit or a logic for accessing the memory device, are driven at different clock frequencies.

In addition, an embodiment of the present disclosure can provide an apparatus and a method for avoiding or reducing deterioration of operating performance in the system-on-chip (SoC) by accessing a memory device with an operating speed lower than a data transfer or communication speed within the system-on-chip (SoC) through an interleaving method.

In an embodiment of the present disclosure, a system-on-chip can include plural components configured to perform separate functions, separate calculations or separate operations; and a bus interface configured to support data communication between the plural components according to a point-to-point interconnect protocol. At least one component of the plural components can be operatively engaged with a memory device. The at least one component can include plural memory interfaces configured to access the memory device in an n-way interleaving way, where n is a positive integer which is equal to or greater than 2; and at least one slave intellectual property (IP) core configured to distribute and transmit, to the plural memory interfaces, plural commands that are input through the bus interface.

The at least one slave IP core can be configured to operate according to a first clock. The plural memory interfaces can be configured to operate according to a second clock. The first and second clocks can respectively have first and second frequencies different from each other.

The first frequency is higher than the second frequency.

A ratio of the first frequency to the second frequency can depend on a ratio of a first number of the plural memory interfaces to a second number of the at least one slave IP core.

The first number can be four times the second number.

The second frequency can be greater than or equal to a value which is obtained by: multiplying the first frequency by 2 to obtain a first multiplication value; multiplying the first multiplication value by the second number to obtain a second multiplication value; and dividing the second multiplication value by the first number.

The at least one slave IP core can include a write module configured to sequentially transmit, to the plural memory interfaces, write commands and write data input through the bus interface and configured to output, to the plural components, responses corresponding to the write commands; and a read module configured to sequentially transmit read commands input through the bus interface and output read data corresponding to the read commands.

A first number of the plural memory interfaces is twice a second number of the at least one slave IP cores.

The at least one slave IP core further can include a gating logic configured to perform at least one operation of: distributing and transferring, to the plural memory interfaces, the write commands and the write data transmitted from the write module; and collecting the read data transmitted from the plural memory interfaces to transfer the read data to the read module.

A first number of the plural memory interfaces can be four times a second number of the at least one slave IP cores.

The gating logic can include a first arbitration circuit configured to parallelly process the write commands and the write data; a first switching circuit configured to collect and transmit the responses to the plural components; a second arbitration circuit configured to parallelly process the read commands; and a second switching circuit configured to collect and transmit the read data to the read module.

In another embodiment of the present disclosure, a system-on-chip can include plural components configured to perform separate functions, separate calculations or separate operations; and a bus interface configured to support data communication between the plural components according to a point-to-point interconnect protocol. At least one component of the plural components can include a first area comprising plural memory cells for storing data; and a second area comprising a logic or a circuit configured to input or output the data to or from the first area. A second planar size of the second area can be 50 to 65 times a first planar size of the first area.

The plural memory cells are arranged in rows and columns. Each of the plural memory cells can be a Static Random Access Memory (SRAM) cell.

The logic or the circuit can include plural memory interfaces configured to access the plural memory cells in an n-way interleaving way, where n is a positive integer which is equal to or greater than 2; and at least one slave intellectual property (IP) core configured to distribute and transmit, to the plural memory interfaces, plural commands that are input through the bus interface.

The at least one slave IP core can be configured to operate according to a first clock. The plural memory interfaces can be configured to operate according to a second clock. The first and second clocks can respectively have first and second frequencies different from each other.

A number of the at least one slave IP core can be m, where m is a positive integer. The second frequency can be equal to or greater than a value obtained by: multiplying the first frequency by 2 to obtain a multiplication value; and multiplying the multiplication value by m/n.

In another embodiment of the present disclosure, a memory system can include n number of memories, where n is a positive integer which is equal to or greater than 2; at least one slave intellectual property (IP) circuit coupled to a bus interface and configured to receive commands; and a gating logic configured to distribute and transmit the commands input from the at least one slave IP circuit to the n number of memories for accessing the n number of memories in an n-way interleaving manner.

Each of the n number of memories can include plural memory cells for storing data; a memory interface configured to access the plural memory cells; and a data path circuit coupled to the memory interface.

Each of the plural memory cells can be a Static Random Access Memory (SRAM) cell. A planar size occupied by the plural memory cells can account for 98 to 98.5% of a total planar size of the memory system.

The at least one slave IP circuit can be configured to parallelly process a write command and a read command for the n number of memories.

The at least one slave IP core and the gating logic can be each configured to operate according to a first clock. The n number of memories can be configured to operate according to a second clock. The first and second clocks can respectively have first and second frequencies different from each other.

A number of the at least one slave IP core is m, where m is a positive integer. The second frequency can be equal to or greater than a value obtained by: multiplying the first frequency by 2 to obtain a multiplication value; and multiplying the multiplication value by m/n.

The n number of memories can have a same data storage capacity.

The commands can be provided from a master intellectual property (IP) circuit. The bus interface can be further configured to transfer the commands into the at least one slave IP circuit according to a point-to-point interconnect protocol.

These and other features and advantages of the invention will become apparent from the detailed description and the accompanying drawings of embodiments of the present disclosure. Embodiments will now be described with reference to the accompanying drawings, wherein like numbers reference like elements.

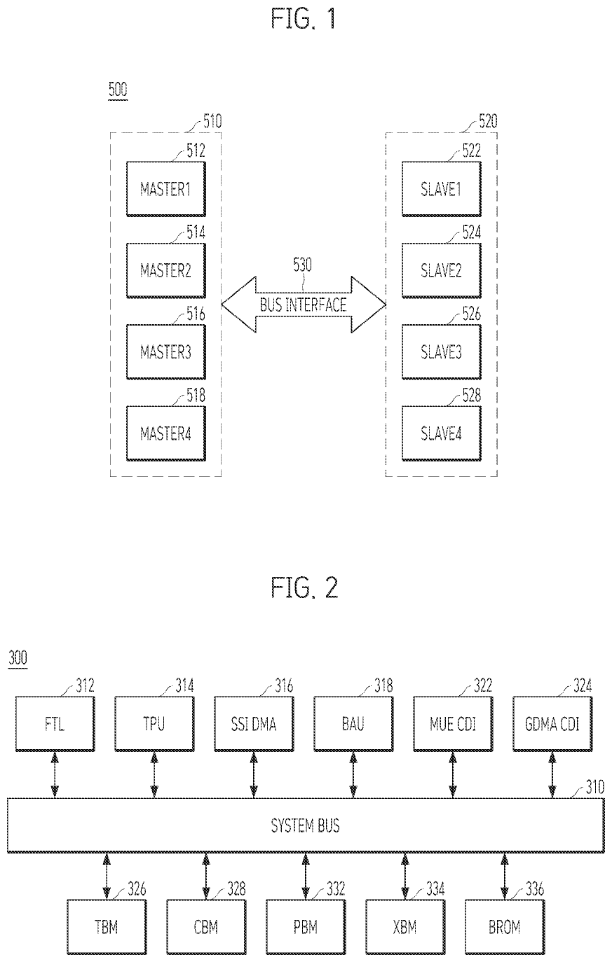

FIG. 1 illustrates a system-on-chip (SoC) according to an embodiment of the present disclosure.

Referring to FIG. 1, a system-on-chip 500 may include a master circuit (or a first logic) 510 and a slave circuit (or a second logic) 520. The master circuit (or the first logic) 510 and the slave circuit (or the second logic) 520 may be connected through a bus interface 530. The bus interface 530 may include at least one bus subsystem to support data communication between the master circuit (or the first logic) 510 and the slave circuit (or the second logic) 520. As an example of the bus subsystem to which technical ideas described in this specification are applied, the AMBA AXI Protocol Specification (published and obtained at http://www.arm.com) is incorporated herein by reference in its entirety.

The system-on-chip 500 may be an integrated circuit (IC) that combines multiple electronic components or subsystems, such as processors, memory devices, I/O controllers, and special function blocks/circuitries, into a single chip. These components or subsystems may typically be implemented as an intellectual property (IP) core. The system-on-chip 500 could be small and energy efficient, so it could be designed to perform most or all functions of an electronic system in a cost-effective manner. The system-on-chip 500 could be widely used in various applications such as a smartphone, a tablet, an embedded system, an automotive electronic, and an Internet of Things (IoT) device.

The system-on-chip 500 can reduce an overall space of a system by integrating multiple components into a single chip. Based on these advantages, the system-on-chip 500 can be applied in a portable and wearable electronic device. Additionally, the system-on-chip 500 could be designed for energy efficiency through tightly integrated components that share resources and communicate efficiently to minimize power consumption. These benefits can help extend battery life in a portable device and improve consumer satisfaction. Additionally, the system-on-chip 500 integrating multiple components into a single chip can reduce the number of components that should be purchased, assembled, and tested, for reducing a manufacturing cost of the system. Although design and manufacturing of the system-on-chip 500 may be more complex, reduction in the number of parts and assembly steps for a system that includes the system-on-chip 500 may lead to cost savings at scale. Further, the system-on-chip 500 can be useful for optimizing communication and data transfer between different subsystems to minimize latency and improve overall performance, enabling these optimization features to be utilized in an application that requires real-time processing, such as video playback or augmented reality.

Referring to FIG. 1, the master circuit (or the first logic) 510 may include a plurality of master modules 512, 514, 516, 518. The slave circuit (or the second logic) 520 may include a plurality of slave modules 522, 524, 526, 528. Depending on functions and operations to be implemented in the system-on-chip 500, the number of master modules or slave modules included in the master circuit (or the first logic) 510 and the slave circuit (or the second logic) 520 may vary. The bus interface 530 may support data communication between the plurality of master modules 512, 514, 516, 518 and the plurality of slave modules 522, 524, 526, 528.

An example of the bus interface 530 can be an Advanced extensible Interface (AXI). The AXI is one of point-to-point interconnect protocols for communication between various components within the system-on-chip 500, such as processors, memory interfaces, and peripherals. The AXI can be designed to address the needs of high-performance, high-frequency system design. The AXI can be used in the system-on-chip 500 to facilitate communication between various intellectual property (IP) cores or modules, such as processors, memory controllers, and peripherals. The AXI can form a part of the broader ARM Advanced Microcontroller Bus Architecture (AMBA), which includes other protocols such as Advanced High-performance Bus (AHB) and Advanced Peripheral Bus (APB). The AXI can improve overall system performance by enabling high-throughput communication, low latency, and efficient data transfer between components within the system-on-chip 500. Additionally, the AXI can support command pipelining, which could reduce latency and increase data transfer efficiency. This functionality may allow plural components within the system-on-chip 500 to send multiple requests, such as a second request to each other, without waiting for a response to the first request from a specific component. Further, the AXI can have the characteristic of improving interconnection throughput and utilization by allowing transactions to be completed out-of-order.

Additionally, the AXI can support burst transactions, allowing efficient transfer of large, continuous data. An AXI protocol could separate read and write channels, allowing simultaneous read and write operations and improving transaction concurrency. The AXI can be suitable for supporting flexible data widths and multiple high-performance transactions, providing separate channels for read and write transactions, enabling efficient data transfer with low latency, and enabling high-speed data transfers, pipelined operations, and multiple concurrent accesses on shared resources.

The AXI has various versions. For example, AXI3 is an early AXI protocol that introduces basic concepts such as separate read and write channels, multiple outstanding transactions, and early burst termination. AXI4 is an enhanced version of the AXI protocol that provides improved performance, simplified design, and support for atomic operations. Further, there is the AXI4-Lite profile, which simplifies communication with non-performance-critical peripherals and enables low-cost implementation. AXI4-Stream is a subset of the AXI4 protocol specifically designed for one-way data streaming without address and control information associated with individual data transmissions. The AXI4-Stream could be used for direct memory access (DMA) operations, data transfer between IP cores, and communication with streaming peripherals.

In the master circuit (or the first logic) 510, the plurality of master modules 512, 514, 516, 518 may include an apparatus for transferring data and address information. For example, each of the plurality of master modules 512, 514, 516, 518 may include a processor, a DMA controller, or a various data transfer element. The plurality of master modules 512, 514, 516, 518 may communicate with the plurality of slave modules 522, 524, 526, 528 through a processing unit and time multiplexing. The plurality of master modules 512, 514, 516, 518 may perform a transaction with at least one slave module by sending addresses, data, control signals, and other details.

The plurality of slave modules 522, 524, 526, 528 may include an apparatus that receives and processes data and address information received from at least one master module. For example, the plurality of slave modules 522, 524, 526, 528 include data storage elements such as a memory or an input/output (I/O) interface. The plurality of slave modules 522, 524, 526, 528 can receive, store, or process data delivered from the plurality of master modules 512, 514, 516, 518, and send or transmit control, result, error, or status information or other detailed information, as a response signal, to the plurality of master modules 512, 514, 516, 518.

In the system-on-chip 500, the plurality of master modules 512, 514, 516, 518 can perform a role of starting a transaction and transmit data. The plurality of slave modules 522, 524, 526, 528 can perform a role of receiving the transaction and processing or storing the data. The interaction of the plurality of master modules 512, 514, 516, 518 with the plurality of slave modules 522, 524, 526, and 528 can determine overall performance and efficiency of the system-on-chip 500.

FIG. 2 illustrates another system-on-chip (SoC) according to another embodiment of the present disclosure.

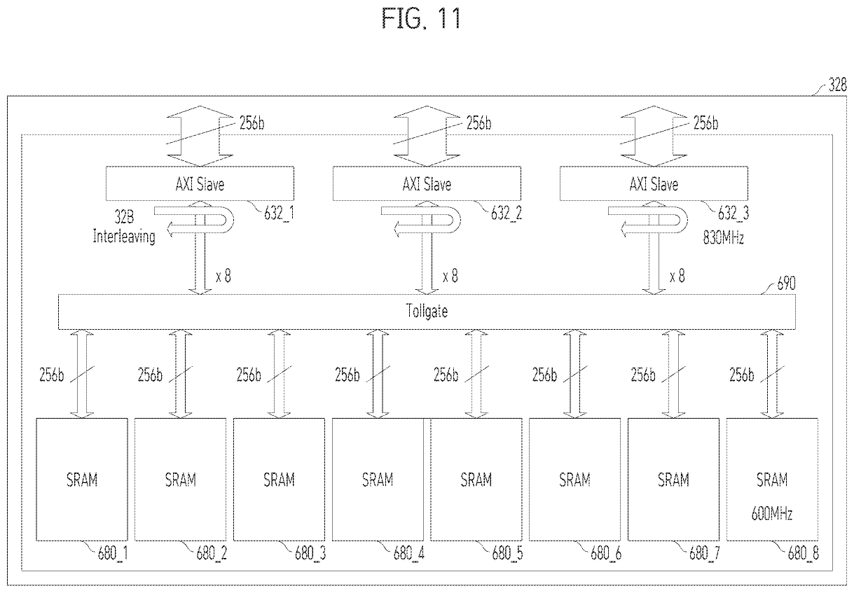

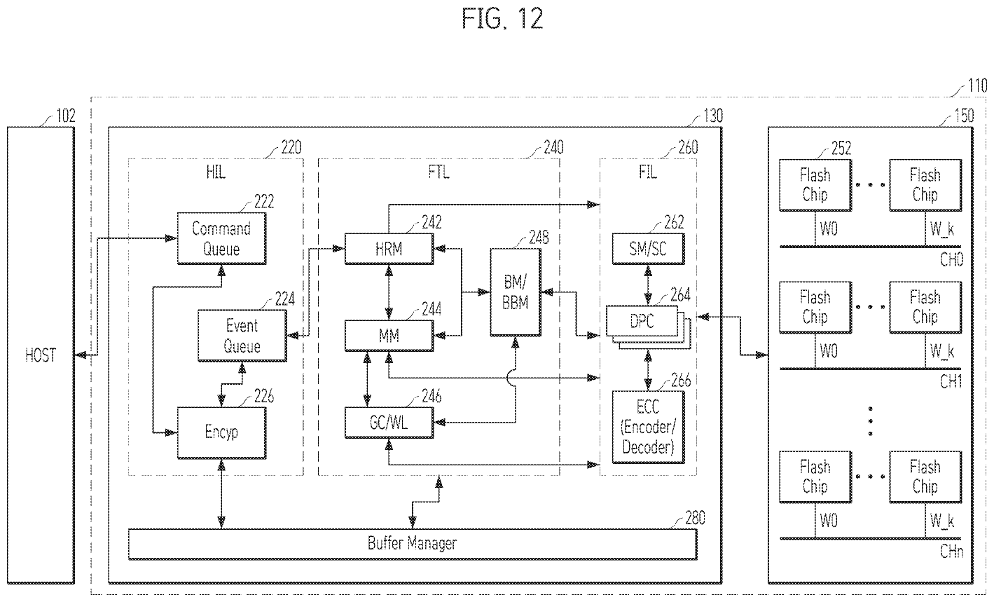

Referring to FIG. 2, a system on a chip (SoC) 300 may include a plurality of components connected to a system bus 310. Herein, the system bus 310 may include the bus interface 530 described in FIG. 1. Additionally, the plurality of components connected to the system bus 310 may include the plurality of master modules 512, 514, 516, 518 or the plurality of slave modules 522, 524, 526, 528 described in FIG. 1. According to an embodiment, at least some of the plurality of components may include both a master module and a slave module. Additionally, according to an embodiment, the system on chip (SoC) 300 may be included in controllers 130, 400 configured to control a memory device (see FIGS. 11 and 12).

A flash translation layer (FTL) 312 is coupled to the system bus 310. The flash translation layer (FTL) 312 can be configured to change a logical address of data used externally to a physical address of data used internally, and solve issues such as delays, latencies or bottlenecks, which occur due to various operations that are performed while different addresses are used externally and internally. Further, the flash conversion layer (FTL) 312 may perform various operations to improve the operating efficiency, reduce error occurrence, or improve a lifespan of non-volatile memory devices connected to the controllers 130, 400. A detailed description of the flash conversion layer (FTL) 312 will be described later with reference to FIGS. 11 and 12.

A Tensor Processing Unit (TPU) 314 is shown as an example of a microprocessor included in the system-on-chip (SoC) 300. The system-on-chip (SoC) 300 may include a plurality of microprocessors to perform various functions. A typical central processing unit (CPU) can perform a variety of functions, but it could be very large and resource-consuming. On the other hand, a microprocessor such as the tensor processing unit (TPU) 314 can be designed to perform a specific function or operation. The microprocessor may be small in size and consume less resources. According to an embodiment, the system-on-chip (SoC) 300 may include at least one microprocessor.

An SSI DMA 316 can refer to a type of Direct Memory Access (DMA) controller that handles data transfer to and from Synchronous Serial Interface (SSI) peripherals, such as Serial Peripheral Interface (SPI) or Inter-IC Sound (I2S). The SSI DMA 316 can manage data transmission and data movement, reducing the burden on the flash translation layer (FTL) 312 or the tensor processing unit (TPU) 314 for operations or tasks of transmitting and moving data or signals, so that the flash translation layer (FTL) 312 or the tensor processing unit (TPU) 314 can perform other tasks. Through this scheme, the SSI DMA 316 can improve data processing performance of the system-on-chip (SoC) 300.

A bitrate adaptation unit (BAU) 318 can be a module in the system-on-chip (SoC) 300, which is configured to adjust a bit rate of data communication performed through the system bus 310, etc. The bitrate adaptation unit (BAU) 318 may handle adaptation of the bit rate according to a channel condition or a system requirement to optimize throughput, latency, or power consumption.

A Multipath Effects Common Data Interface (MUE CDI) 322 can protect against signal interference and distortion caused by data or signals moving along different paths between a transmitter and a receiver during data communication. Alternatively, it may include a circuit, a module or an algorithm designed to mitigate or compensate for effects of multipath effects (MUE), such as fading. Additionally, the multipath effect public interface (MUE CDI) 322 can provide an interface used to exchange data or signals between components (e.g., IP blocks, controllers, or peripherals) within the system-on-chip (SoC) 300.

A General Direct Memory Access Common Data Interface (GDMA CDI) 324 can be a type of DMA controller that handles data transfer within the system-on-chip (SoC) 300 using a standardized interface. The GDMA CDI 324 may provide an interface used to exchange data or signals between components (e.g., IP blocks, controllers, or peripheral devices) within the system-on-chip (SoC) 300. The GDMA CDI 324 can enable efficient and flexible resource utilization for various types of data transactions.

The system-on-chip (SoC) 300 may include various memory modules. For example, the system-on-chip (SoC) 300 can include a core-based memory (e.g., Tiny Basic Memory (TBM) 326), a controller-based memory (CBM) 328, and a processor-based memory (PBM) 332, an execution-based memory (e.g., execution Basic Memory (XBM) 334), and a boot read-only memory (BROM) 336).

The execution-based memory (XBM) 334 may store firmware or program codes executed in the system-on-chip (SoC) 300, or may store data generated in relation to the firmware or the program codes executed in the system-on-chip (SoC) 300.

The core-based memory (TBM) 326 can contain small pieces of memory that is tightly coupled to a processor core and provides a lowest latency access. The core-based memory 326 can often be used to store critical sections of codes or data in a real-time application. The core-based memory (TBM) 326 can be used for a specific task or operation in conjunction with the processor core to improve operating efficiency of the system-on-chip (SoC) 300.

The controller-based memory (CBM) 328 may include a memory configuration where a dedicated memory controller manages access to the memory. A dedicated memory controller may include an intellectual property (IP) block or circuitry that efficiently coordinates requests from multiple IP cores or devices within the system-on-chip (SoC) 300 for memory access. As an example of the controller-based memory (CBM) 328, there is a Double Data Rate (DDR) controller-based memory where a separate controller is responsible for interfacing with a DDR memory.

The processor-based memory (PBM) 332 may include a memory organization in which a processor (CPU) or a microprocessor itself can manage memory access and control. Herein, the processor or the microprocessor may be directly connected to the processor-based memory (PBM) 332 without an intermediate controller. In the processor-based memory (PBM) 332), the processor can have efficient memory access. However, a bottleneck may occur when multiple IP blocks compete for memory access. The processor-based memory (PBM) 332 may often be used as a cache memory or an internal system-on-chip (SoC) memory (e.g., an on-chip memory).

The boot read-only memory (BROM) 336 can be a type of non-volatile memory that contains initial boot codes (also well known as a bootloader or firmware) used to start a system, such as a microcontroller, a microprocessor, or a system. The boot read-only memory (BROM) 336 may be required for the system to initialize and execute essential functions such as hardware initialization and starting an operating system or an application code. The boot read-only memory (BROM) 336 can provide security and reliability because it is difficult to change or erase after programmed therein.

The system-on-chip (SoC) 300 described in FIG. 2 discloses a plurality of memory modules corresponding to various purposes and uses. According to an embodiment, the system-on-chip (SoC) 300 can be implemented including at least some of the plurality of memory modules. When the plurality of memory modules can input and output data in response to an operating speed of the system bus 310, it is possible to avoid or reduce deteriorating operating performance of the system-on-chip (SoC) 300 due to the plurality of memory modules. The operating speed of a volatile memory or a non-volatile memory included in or linked to the plurality of memory modules may be lower than the operating speed of the system bus 310. In this operating environment, each of the plurality of memory modules can support memory access through an interleaving way or scheme, thereby improving data input/output performance of an overall system or subsystem.

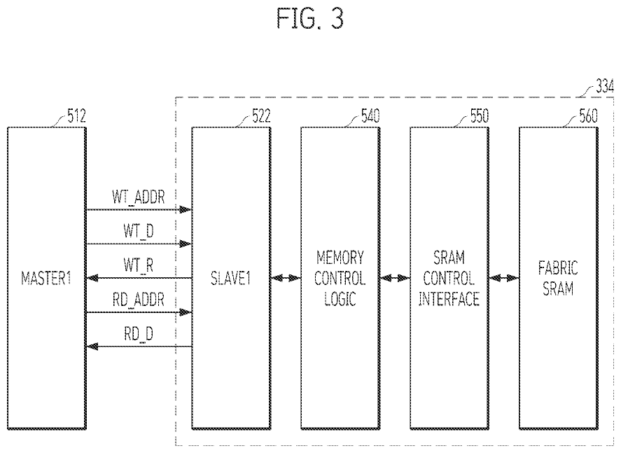

FIG. 3 illustrates a memory subsystem according to an embodiment of the present disclosure.

Referring to FIGS. 1 to 3, a write address WT_ADDR, write data WT_D, a write response WT_R, a read address RD_ADDR, read data (RD_D), etc. can be transmitted and received between the first master module 512 and the first slave module 522. The performance-based memory 334 may include the first slave module 522. FIG. 3 illustrates the performance-based memory 334 as an example, but depending on an embodiment, the core-based memory (e.g., Tiny Basic Memory (TBM) 326, the controller-based memory (CBM) 328, or the processor-based memory (PBM) 332 described in FIG. 2 may also have a similar configuration.

The performance-based memory 334 may include the first slave module 522, a memory control logic 540, a memory control interface 550, and a memory structure 560. The memory structure 560 may include a static random access memory (SRAM) memory cell. Depending on an embodiment, the memory structure 560 may include not only Static Random-Access Memory (SRAM) but also Dynamic Random-Access Memory (DRAM) or Synchronous Dynamic Random-Access Memory (SDRAM).

According to an embodiment, the first slave module 522 may include an intellectual property (IP) core that can provide an AXI slave interface for connection to the first master module 512 or an AXI interconnection bus interface (e.g., the system bus 310). The first slave module 522 may support single bit or burst transactions. Additionally, the first slave module 522 may include a plurality of components that can carry out or handle read and write operations separately and independently. For example, a plurality of components in the first slave module 522 may be coupled to a channel for a read operation or a channel for a write operation within the system bus 310.

The memory control logic 540 may include a finite state machine (FSM) that performs read/write operations on the memory structure 560. The memory control logic 540 can be configured to exchange data and signals between the first slave module 522 and the memory control interface 550, generate control signals necessary to access the memory structure 560, or control process of passing commands and data used for accessing the memory structure 560. Additionally, the memory control logic 540 can perform write and read channel arbitration and address decoding when an error correction circuitry (ECC) is activated. For example, the error correction circuitry (ECC) may include circuits for performing exclusive OR (XOR) operations. Write and read channel arbitration may be implemented based on a round robin algorithm. When both the write channel and the read channel are simultaneously activated through the first slave module 522, the memory control logic 540 may perform the write and read channel arbitration. Additionally, the memory control logic 540 may be configured to generate an address for a read or write operation corresponding to the memory structure 560 based on an address received through the first slave module 522 through address decoding.

According to an embodiment, when the ECC is disabled, the memory control logic 540 may not perform the write and read channel arbitration. If a user performs write and read operations on a same location at a same time, the performance-based memory 334 may have difficulty outputting read data through the read channel. In this case, the first master module 512 may delay performance of the read operation and schedule the performance-based memory 334 to perform the read operation after performing the write operation for the corresponding location.

According to an embodiment, when the ECC is enabled, the memory control logic 540 can use a read-modify-write (RMW) mechanism. To reduce a latency which can increase due to the read-modify-write (RMW) mechanism, the ECC may include pipeline structures (e.g., address pipeline and data pipeline).

The memory control interface 550 can perform read and write operations on the memory structure 560. The memory control interface 550 may generate control signals for read and write operations corresponding to a type of memory structure 560. The memory control interface 550 may align addresses and data received from the first slave module 522 to match the addresses and the data configured to be suitable for the memory structure 560.

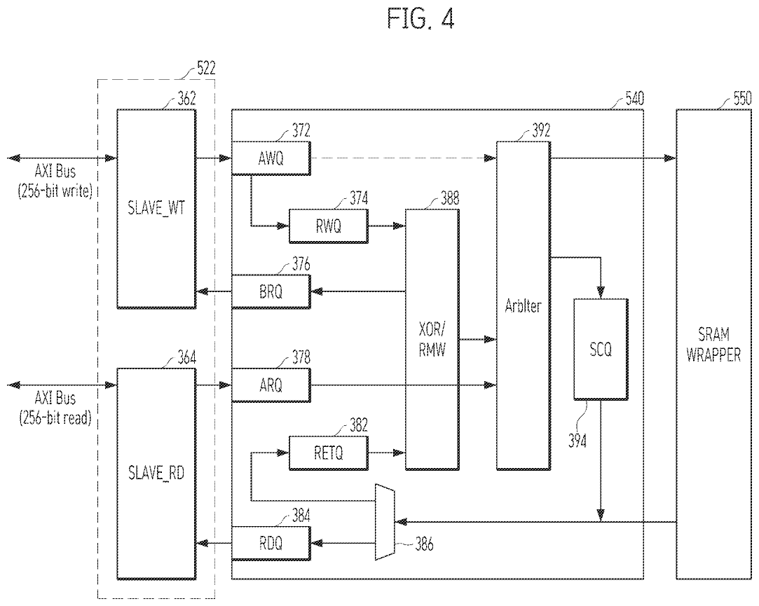

FIG. 4 shows a first internal configuration of the memory subsystem described in FIG. 3.

Referring to FIG. 4, the first slave module 522 may include a write IP block 362 and a read IP block 364. Because the Advanced extensible Interface (AXI) can provide separate channels for read and write operations, data input/output performance could be improved when the memory subsystem performs read and write operations in parallel. The memory control logic 540 and the memory control interface 550 may support an interleaving way or scheme to perform read and write operations in parallel.

According to an embodiment, the memory control interface 550 may include a Static Random Access Memory (SRAM) wrapper. The SRAM wrapper can include a digital design block that serves as an interface between the memory structure 560 containing SRAM memory cells and the rest of the system, typically built on industry standard bus protocols such as AXI, AHB, or APB. The SRAM wrapper can translate and manage communication signals and protocols between the memory structure 560 and a device that needs to read from or write to the memory structure 560.

For example, the SRAM wrapper can convert signals and instructions from a system bus protocol (such as AXI) into a format required by the memory structure 560 for proper operation, and vice versa. Additionally, the SRAM wrapper can handle address decoding to assign and map memory addresses in the memory structure 560 to the address space of the device accessing the memory structure 560. The SRAM wrapper can manage a flow of read and write data as well as control signals between the memory structure 560 and another device, ensuring accurate timing and synchronization during memory access operations. In a system where multiple devices or masters need to access SRAM simultaneously, the SRAM wrapper can integrate an arbitration logic to manage access requests fairly and efficiently, preventing conflicts and system bottlenecks. Additionally, depending on an embodiment, the SRAM wrapper may include logics or circuitries for performing features such as error detection and correction, power management, and testability support.

The memory control logic 540 arranged between the first slave module 522 and the memory control interface 550 may include an arbitration logic 392. In the system-on-chip (SoC) 300 with an AXI interface, the write IP block 362 and the read IP block 364 in the first slave module 522 can communicate with the memory structure 560 through the memory control interface 550. The arbitration logic 392 can be configured to manage access requests and grant control to devices in an organized manner if necessary. The primary role of the arbitration logic 392 is to control whether the write IP block 362 and read IP block 364 have a fair opportunity to access memory structure 560 while maintaining overall system performance.

The arbitration logic 392 may monitor access request signals in the write IP block 362 and the read IP block 364 of systems that need to communicate with memory structure 560. When multiple access requests arrive simultaneously or during overlapping periods, the arbitration logic 392 may use a specific algorithm to determine which request to process first. For example, the arbitration logic 392 may operate based on an arbitration policy such as a fixed priority, a round robin, or a weighted round robin.

According to an embodiment, a fixed priority scheme can assign a static priority level to each AXI slave device. The arbitration logic 392 may process requests from high-priority slave devices first and process requests from low-priority slave devices later.

In a round robin manner, the arbitration logic 392 can process requests in a circular order and treat all AXI slave devices equally, ensuring equal access opportunities regardless of priority. For example, access request signals transmitted from the write IP block 362 and the read IP block 364 may be processed in a circular order.

In a weighted round robin scheme, the arbitration logic 392 may operate based on a combination of round robin and priority where each AXI slave device is assigned a weight or a priority level. The arbitration logic 392 can process requests in a round-robin manner, and can determine the amount of service each device receives by considering assigned weights for each device.

Once the arbitration logic 392 determines which AXI slave device request to acknowledge, the arbitration logic 392 can generate an acknowledgment signal for the selected device to access the memory control interface 550 for read or write operations as requested. The arbitration logic 392 may manage data flow and address information between the write IP block 362 or the read IP block 364 within the first slave module 522 and the memory control interface 550 during read and write transactions or operations. The arbitration logic 392 can manage active transactions while continuously monitoring access requests to ensure smooth operation of the AXI bus and optimize access to shared SRAM resources.

To access the memory structures 560 in an interleaved manner within a memory subsystem, the arbitration logic 392 can include a control mechanism to manage tasks from multiple sources through interleaved requests or a specific order or method and regulate access shared resources such as memory or communication channels. The interleaving way or scheme can be used to improve performance and increase concurrency in a variety of systems such as a computer memory, a data storage, and parallel computing. In the interleaving scheme, the arbitration logic 392 can prioritize requests from different sources, manage concurrent access attempts, and allocate shared resources in an efficient manner. The arbitration logic 392 may determine the priority of access, considering factors such as fairness, latency, and overall performance.

Additionally, the memory control logic 540 may include an ECC burst logic 388. As described in FIG. 3, the ECC burst logic 388 may perform an operation based on ECC activation (e.g., performing an ECC operation based on an XOR operation) and a read-modify-write mechanism (RMW Mechanism). The ECC burst logic 388 may include a pipeline structure to reduce a delay or latency.

The memory control logic 540 may include a plurality of queues/queues to support operations of the arbitration logic 392 and the ECC burst logic 388. An Allocating Write Queue (AWQ) 372 in the memory control logic 540 may include a data structure that can temporarily maintain write operations pending for data allocation. A write request transmitted from the write IP block 362 may wait in the allocation write queue 372. While a write request is waiting in the allocation write queue 372, the memory control logic 540 can process waiting write requests by allocating the memory structure 560 or resources so that a necessary space can be available before a write operation corresponding to a write request is performed.

A Retiring Write Queue (RWQ) 374 may include a data structure that holds write operations pending for data retirement, e.g., updating, deleting, or deallocating data in a memory. If write operations are stopped, memory resources could be secured by removing old or no longer needed data. The retiring write queue 374 can hold and support write requests to be processed sequentially or in a prioritized manner depending on a specific requirement.

A write response queue (BRQ) 376 may include a data structure that holds write operations pending until completion of the write operations. When the ECC burst logic 388 checks that write data is stored in the memory structure 560, a response to the write operation corresponding to the write data may be output to the first slave module 522.

An Allocating Read Queue (ARQ) 378 in the memory control logic 540 may include a data structure that can temporarily maintain a read request transmitted from the read IP block 364. Additionally, the Read Data Queue (RDQ) 384 may include a data structure capable of temporarily maintaining read data in response to the read request to be output to the first slave module 522.

Data transmitted through the memory control interface 550 can include not only read data output in response to a read request, but also ECC read data read from the memory structure 560 for an ECC operation. A multiplexer 386 can be configured to distinguish the read data and the ECC read data and transmit the read data and the ECC read data to the read data queue 384 or the ECC read data queue 382 individually.

A Submission Completion Queue (SCQ) 394 can be used with I/O operations such as read requests to manage completion status and notifications of submitted requests. After an execution order of requests can be determined through the arbitration logic 392, a read request may be transmitted to the memory control interface 550. In order to check whether read data corresponding to the read request transmitted to the memory control interface 550 is output from the memory control interface 550, the submission completion queue 394 may temporarily maintain the corresponding read request.

FIG. 4 specifically describes the memory control logic 540, but components within the memory control logic 540 may change according to an embodiment. For example, a logic or a circuit may be added or changed, according to an operation performed in the memory control logic 540 and performance required for the memory control logic 540.

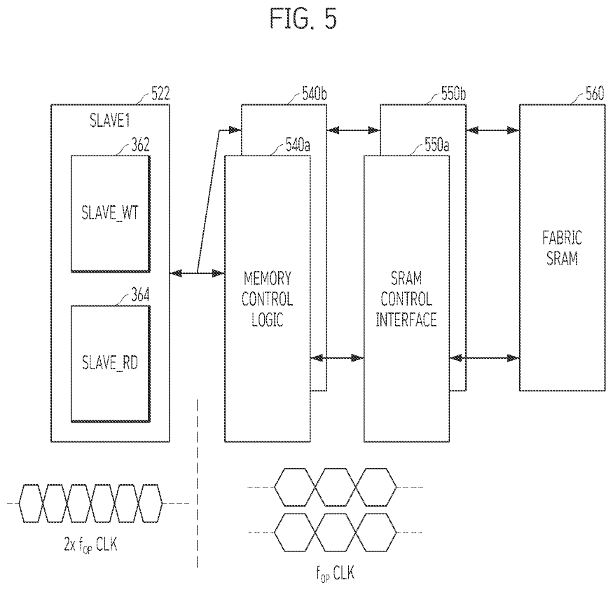

FIG. 5 shows a second internal configuration of the memory subsystem described in FIG. 3.

Referring to FIG. 5, a memory subsystem can include a first slave module 522, first and second memory control logics 540a, 540b, first and second memory control interfaces 550a, 550b, and a memory structure 560.

The first slave module 522 may include a write IP block 362 and a read IP block 364. The first slave module 522 may support a bus interface having separate channels for performing write operations and read operations.

The memory subsystem described in FIG. 5 can perform operations to control and manage access to the memory structure 560 in a 2-way interleaving method. For example, the first memory control logic 540a and the first memory control interface 550a can control and manage transmission of commands or data for performing read operations, while the second memory control logic 540b and the second memory control interface 550b can control and manage transmission of commands and data for performing write operations. In this case, even if a read operation and a write operation are requested simultaneously through the first slave module 522, the memory structure 560 can be accessed through separate command and data paths, thereby avoiding a bottleneck in the memory subsystem.

At this time, frequencies of clocks (CLK) driving the first slave module 522, the memory structure 560, the first and second memory control logics 540a, 540b, and the first and second memory control interfaces 550a, 550b may be different. When compared with a frequency (f_{OP} CLK) of a first clock driving the memory structure 560, the first and second memory control logics 540a, 540b, and the first and second memory control interfaces 550a, 550b, a frequency (2× f_{OP} CLK) of a second clock driving the first slave module 522 may be twice as fast.

If an operating speed of the memory structure 560 is low (driven by a low frequency clock), a size (e.g., a planar size) of the memory structure 560 could be reduced. Conversely, if the operating speed of the memory structure 560 is high (driven by a high frequency clock), it may be difficult to reduce the size of the memory structure 560. The size of the memory structure 560 could be increased for operational safety. This may occur due to the relationship between the size and the operating speed of components such as transistors included in the memory structure 560. According to an embodiment, an advanced manufacturing technology might be applied to increase an operation speed of the memory structure 560 while reducing the size of the memory structure 560, but this may have a disadvantage of increasing the manufacturing cost of the memory structure 560 or the memory subsystem.

Referring to FIGS. 1 to 5, a data storage capacity of the memory structure 560 may increase depending on the required performance of the system-on-chip (SoC) 300 including the memory subsystem including the memory structure 560. For example, the controllers 130, 400 described in FIGS. 11 and 12 may be implemented as a system-on-chip (SoC) 300. The controllers 130, 400 may be configured to perform parallel processing of large amounts of data to achieve better data input/output performance. Even if a memory device 150 including a non-volatile memory with a relatively slow data input/output speed is used, a memory structure 560 that is stable, fast operable, and has a large storage space might be required within the controllers 130, 400, in order to reduce an operation latency that may occur in the controllers 130, 400. For this reason, the size of the memory structure 560 may increase, so that an integration degree of the controllers 130, 400 implemented as the system on a chip (SoC) 300 could be degraded.

However, even if the operating speed of the memory structure 560 included in the system-on-chip (SoC) 300 is not increased or the memory structure 560 is driven in a relatively low operating speed range, the first and second memory control logics 540a, 540b and the first and second memory control interfaces 550a, 550b may support write operations and read operations in an interleaving scheme or way.

The memory structure 560 can be accessed through the first and second memory control logics 540a, 540b and the first and second memory control interfaces 550a, 550b in the interleaving scheme or way after read and write operations are distinguished. Depending on an embodiment, the read and write operations may be processed in the interleaving scheme or way by dividing the read and write operations into access locations (e.g., storage areas indicated by addresses) within the memory structure 560. Additionally, according to an embodiment, all commands transmitted through the first slave module 522 may be processed in the interleaving scheme or way, regardless of a type of task or the access locations. The internal configuration of the first and second memory control logics 540a, 540b and the first and second memory control interfaces 550a, 550b may vary depending on the interleaving scheme or way supported by the memory subsystem.

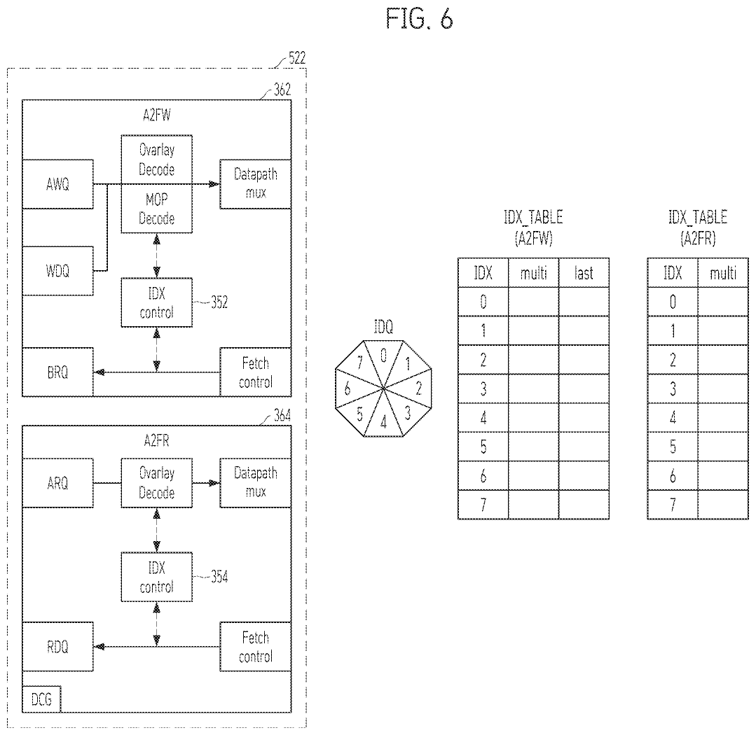

FIG. 6 shows a third internal configuration of the memory subsystem described in FIG. 3.

Referring to FIG. 6, the first slave module 522 included in the memory subsystem may include a write IP block 362 and a read IP block 364. The write IP block 362 and the read IP block 364 may include a plurality of queues/queues that can temporarily store commands or data.

In order to ensure that commands transmitted through the first slave module 522 are performed in an interleaving scheme or way, the write IP block 362 and the read IP block 364 may include index control units 352, 354. When the interleaving scheme or way is supported based on a type of task/operation or access locations of tasks (e.g., an area indicated by an address area) within the memory structure 560, the corresponding command or data may be transmitted via a completely distinct path. In this case, there is no need to use additional information such as a separate index or tag for the corresponding command or data. However, in order for the interleaving scheme or way to be performed regardless of the type of task/operation or the access locations of tasks, additional information should be used to distinguish commands or data to avoid collision or disappearance of tasks/operations, thereby improving operational safety of the memory subsystem.

The first index control unit 352 can use a round index queue (IDQ) of 0 to 7 to assign an index (e.g., one from 0 to 7) to write commands and write data which are individually transmitted from a write allocation queue (AWQ) for temporarily storing the write commands input from the outside and a write data queue (WDQ) for temporarily storing the write data. The write IP block 362 can be configured to check an error (e.g., perform overlay decoding) on the write commands and the write data transmitted from the write allocation queue (AWQ) and the write data queue (WDQ), and perform a macro-operation (MOP) processed by the microprocessor. During the macro-operation (MOP), the index may be assigned to each of the write commands and the write data by the first index control unit 352. Indexed write commands and write data can be transmitted to a data path through a multiplexer. The data path (Datapath) may include the first and second memory control logics 540a, 540b and the first and second memory control interfaces 550a, 550b described in FIG. 5. After the write operation is performed, the write IP block 362 can fetch a response corresponding to the write operation (Fetch Control). The first index control unit 352 can check which index the write command and write data are assigned to. The write IP block 362 can temporarily store the checked response in the write response queue (BRQ). Further, in a burst operation, a write operation may be divided into multiple write sub-operations. An index for a write task or operation can include a separate field (last). Through the index including the separate field, the first index control unit 352 can check whether the multiple write sub-operations have been completed even if the write task or operation is divided into the multiple write sub-operations.

The second index control unit 354 included in the read IP block 364 also uses a round index queue (IDQ) of 0 to 7 to assign an index (e.g., one from 0 to 7) to read commands which are temporarily stored after input from the outside. In addition, the read IP block 364 can fetch the read data (Fetch Control) transmitted from a data path including the first and second memory control logics 540a, 540b and the first and second memory control interfaces 550a, 550b described in FIG. 5. The second index control unit 354 can check which index the read data corresponds to the read command. The second index control unit 354 may store the checked read data in the read data queue (RDQ).

According to an embodiment, the first slave module 522 may include a dynamic clock generator (DCG). The dynamic clock generator (DCG) can generate a clock, a reset signal, a power signal, a clamp signal, or a sequencing used for driving a chip. According to an embodiment, the dynamic clock generator (DCG) may include three phase-locked loops (PLLs) including one phase-locked loop (PLL) having a fixed frequency and the other two phase-locked loops (PLL) having variable frequencies. Herein, the fixed frequency may be a frequency of the clock that can drive the first slave module 522 with 100% performance.

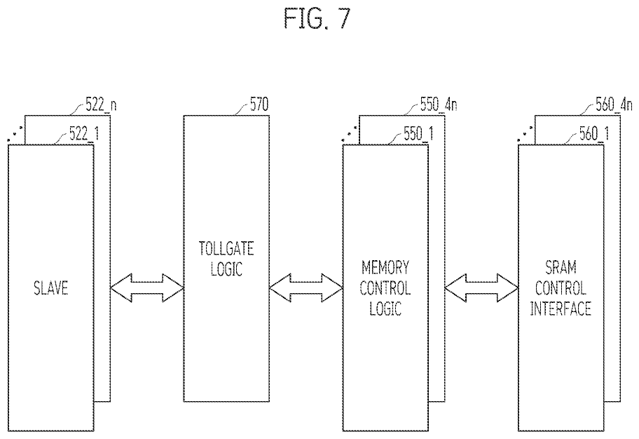

FIG. 7 shows a fourth internal configuration of the memory subsystem described in FIG. 3.

Referring to FIGS. 1 to 7, the memory subsystem may include a plurality of slave modules 522_1 to 522_n. As the data storage space within the memory subsystem increases, the memory subsystem can perform data communication with a plurality of components within the system-on-chip (SoC) 300. The memory subsystem can include the plurality of slave modules 522_1 to 522_n that perform data communication with a plurality of master modules included in a plurality of other components, where ‘n’ is a positive integer equal to or greater than 1. Based on the data communication between the plurality of master modules and the plurality of slave modules 522_1 to 522_n, the memory subsystem can simultaneously perform data input/output operations requested from the plurality of other components.

Referring to FIG. 7, the memory subsystem may include 4n number of memory control logics 550_1 to 550_4n and 4n number of memory control interfaces 560_1 to 560_4n corresponding to n number of slave modules. Each of the n slave modules may include a write IP block and a read IP block. Additionally, a frequency of a first clock used for driving the n number of slave modules may be twice as fast as a frequency of a second clock used for driving the 4n number of memory control logics 550_1 to 550_4n and the 4n number of memory control interfaces 560_1 to 560_4n. Therefore, when commands transmitted through the n number of slave modules are processed using the 4n-way interleaving scheme or way, a latency could be minimized.

To process commands transmitted through the n number of slave modules in the 4n-way interleaving scheme or way, the memory subsystem may include a separate gating logic (or a tollgate logic) 570.

The gating logic (or the tollgate logic) 570 may perform a function of distributing and transferring commands transmitted from the n number of slave modules to the 4n number of memory control logics 550_1 to 550_4n. The gating logic (or the tollgate logic) 570 may include an arbitration logic to distribute the commands transmitted through the n number of slave modules. According to an embodiment, the arbitration logic may distribute the commands to the 4n number of memory control logics 550_1 to 550_4n based on an arbitration policy such as a fixed priority, a round robin, or a weighted round robin.

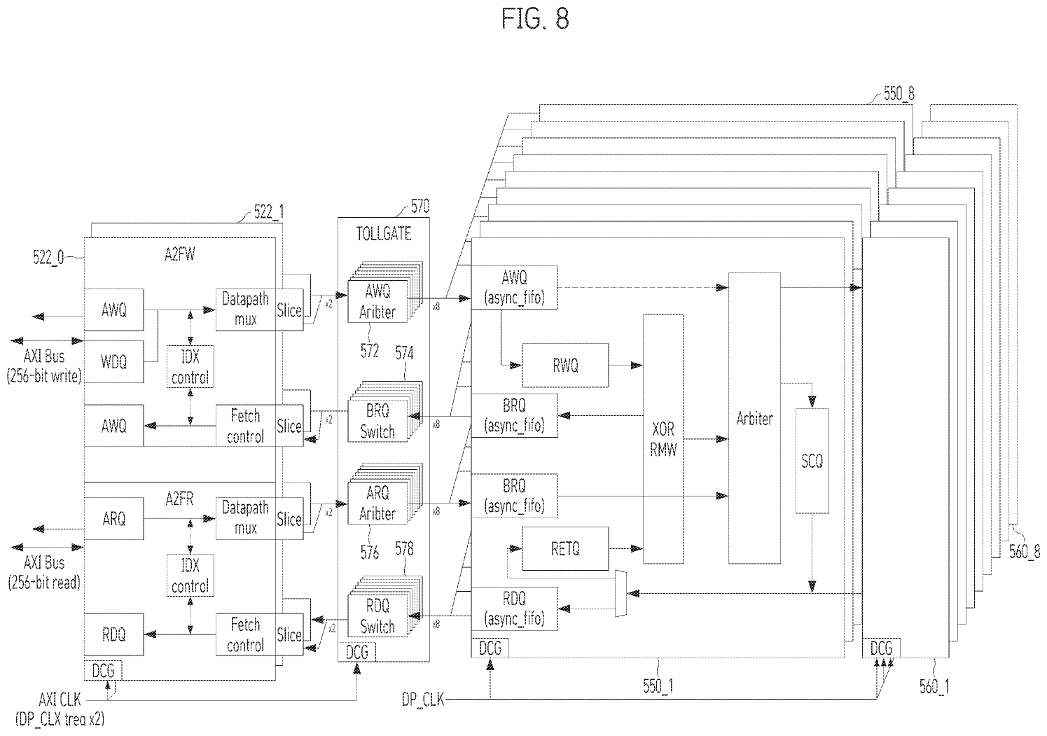

FIG. 8 shows a fifth internal configuration of the memory subsystem described in FIG. 3. Specifically, FIG. 8 describes an example where the memory subsystem described in FIGS. 3 and 7 includes two slave modules, eight memory control logics, and eight memory control interfaces.

Referring to FIG. 8, the memory subsystem includes two slave modules 522_0, 522_1. Each of the slave modules 522_0, 522_1 may include a write IP block (A2FW) and a read IP block (A2FR). The write IP block (A2FW) and the read IP block (A2FR) may individually include an index control unit (IDX control).

The specific configuration and operation of the two slave modules 522_0, 522_1 shown in FIG. 8 have been described in FIG. 6 and are therefore omitted. Additionally, the internal configuration and operation of the eight memory control interfaces 550_1 to 550_8 shown in FIG. 8 have been described in FIG. 4 and are therefore omitted.

The eight memory control interfaces 550_1 to 550_8 and eight memory control interfaces 560_1 to 560_8 can be driven by a data path clock DP_CLK, while the two slave modules 522_0, 522_1 can be driven by the AXI clock (AXI CLK). Depending on an embodiment, a frequency of the AXI clock (AXI CLK) may be twice a frequency of the data path clock DP_CLK.

According to an embodiment, the gating logic (or the tollgate logic) 570 may include a plurality of write arbitration logics 572, a plurality of write response switching logics 574, a plurality of read arbitration logics 576, and a plurality of read data switching logics 578.

The plurality of write arbitration logics 572 may transfer the write commands and the write data transmitted from the two slave modules 522_0, 522_1 to the eight memory control logics 550_1 to 550_8. The plurality of write response switching logics 574 may transfer the write responses received from the eight memory control logics 550_1 to 550_8 to the two slave modules 522_0, 522_1. The plurality of read arbitration logics 576 may transmit the read commands transmitted from the two slave modules 522_0, 522_1 to the eight memory control logics 550_1 to 550_8. The plurality of read data switching logics 578 may transfer the read data delivered from the eight memory control logics 550_1 to 550_8 to the two slave modules 522_0, 522_1.

In FIG. 8, the gating logic (or the tollgate logic) 570 can include a plurality of arbitration logics and a plurality of switching logics. However, according to an embodiment, the plurality of arbitration logics may be included in the gating logic (or the tollgate logic) 570, instead of the plurality of switching logics.

The gating logic (or the tollgate logic) 570 may be driven by an AXI clock (AXI CLK). The gating logic (or the tollgate logic) 570 may be driven with a same clock as the two slave modules 522_0, 522_1. Accordingly, the gating logic (or the tollgate logic) 570 can be driven by a clock having a frequency twice that of a clock used for driving the eight memory control interfaces 550_1 to 550_8.

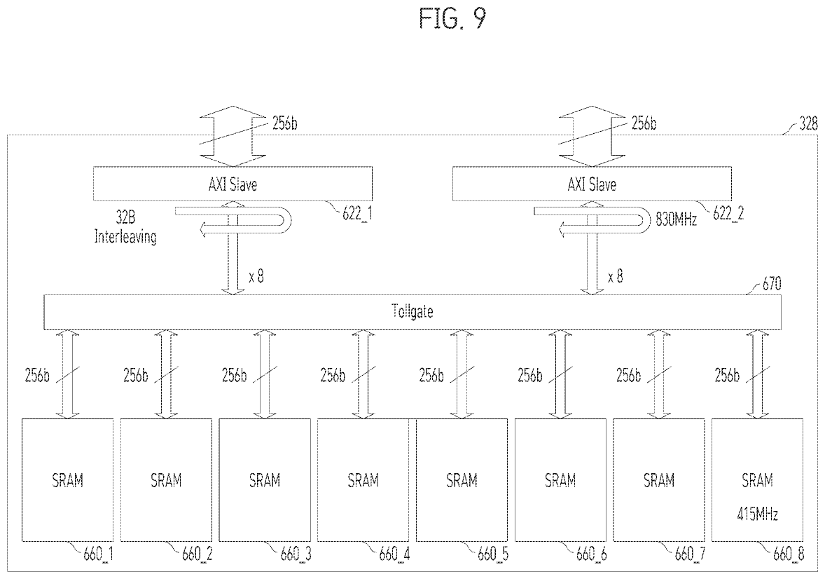

FIG. 9 shows a sixth internal configuration of the memory subsystem described in FIG. 3.

Referring to FIG. 9, the controller-based memory (CBM) 328 may include two slave modules 622_1, 622_2 and eight SRAM modules 660_1 to 660_8. FIG. 9 illustrates the controller-based memory (CBM) 328 as an example. According to an embodiment, the structure shown in FIG. 9 may be applied to other memory modules described in FIG. 3.

Eight SRAM modules 660_1 to 660_8 may correspond to the eight memory control interfaces and eight memory control interfaces described in FIG. 8. Each of the eight SRAM modules 660_1 to 660_8 may include one memory control logic and one memory control interface. According to an embodiment, the eight SRAM module 660_1 to 660_8 can have the same storage capability.

Commands transmitted through the two slave modules 622_1, 622_2 can be processed based on an 8-way interleaving scheme or way. To this end, a tollgate logic 670 may be placed between the two slave modules 622_1, 622_2 and the eight SRAM modules 660_1 to 660_8. The tollgate logic 670 may include components corresponding to the toll gate logic 570 described in FIG. 8.

According to an embodiment, the two slave modules 622_1, 622_2 may be driven by a clock of 830 MHZ, while the eight SRAM modules 660_1 to 660_8 may be driven by a clock of 415 MHz. The two slave modules 622_1, 622_2 can be driven by the clock having a frequency twice as high as the frequency of the clock for the eight SRAM modules 660_1 to 660_8.

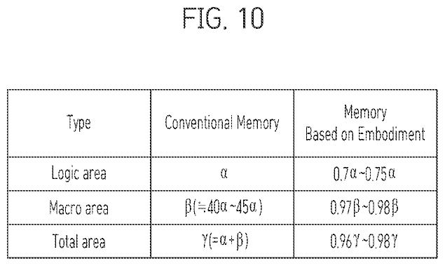

FIG. 10 describes a planar size of the memory subsystem according to an embodiment of the present disclosure. The memory subsystem can be broadly divided into two areas. One of the two areas can be a macro area where a plurality of memory cells is arranged in row and column directions. The other one of the two areas can be a logic area where circuits or logics are arranged and configured to control tasks of performing inputs (writes) or outputs (reads) of data to or from the plurality of memory cells.

Referring to FIG. 10, a planar size of the logic area in a conventional memory subsystem may be a, while a planar size of the macro area may be B. According to an embodiment, planar sizes may be different depending on a type and a storage capacity of the memory cells included in the memory subsystem. When multiple SRAM cells with a storage capacity of 16 MB are included in the macro area, the planar size (B) of the macro area may be greater by about 40 to 45 times than that of the planar size (a) of the logic area. The overall size (e.g., a planar size y) of the conventional memory subsystem may be equal to a sum of the planar size (B) of the macro area and the planar size (a) of the logic area.

Referring to FIGS. 1 to 8, the memory structure 560 including the plurality of memory cells could be accessed in a multi-way interleaving way or scheme. A first clock can be applied to drive or operate not only the memory structure 560 but also a plurality of memory control logics and a plurality of memory control interfaces. A second clock can be applied to drive or operate a bus interface of the system-on-chip (SoC) 300. A frequency of the first clock may be lower than a frequency of the second clock. As the frequency of the first clock driving the plurality of memory control logics and the plurality of memory control interfaces can be lowered, influence of interference, noise, etc. generated from the components included in the plurality of memory control logics and the plurality of memory control interfaces could be lowered or reduced. Therefore, the planar size (a) of the logic area including the plurality of memory control logics and the plurality of memory control interfaces can be reduced. For example, the planar size of the logic area of the memory subsystem according to an embodiment of the present invention may be about 0.7 to 0.75 times that of the logic area of the conventional memory subsystem.

Additionally, because the frequency of the first clock driving the memory structure 560 is not high, the two-dimensional planar size of the memory structure 560 could be reduced without compromising operational safety due to interference, etc. For example, the planar size of the macro area of the memory subsystem according to an embodiment of the present invention may be about 0.97 to 0.98 times that of the macro area of the conventional memory subsystem.

As the planar sizes of the logic area and the macro area of the memory subsystem according to an embodiment of the present invention are reduced, a planar size ratio of the logic area to the macro area may vary. For example, a planar size of the logic area in the memory subsystem according to an embodiment of the present disclosure is about 0.7 to 0.75 times a planer size of the macro area in the conventional memory subsystem, and a planar size of the macro area in the memory subsystem according to the embodiment of the present disclosure is about 0.97 to 0.98 times that of the macro area in the conventional memory subsystem. In an embodiment of the present disclosure, the planar size of the macro area may be about 50 to 65 times that of the logic area.

The total area of the memory subsystem according to an embodiment of the present disclosure may be about 0.96 to 0.98 times the total area of the conventional memory subsystem. As an integration degree of the memory subsystem according to an embodiment of the present disclosure is improved, the integration degree of the system-on-chip (SoC) 300 may also be improved.

FIG. 11 shows a seventh internal configuration of the memory subsystem described in FIG. 3.

Referring to FIG. 11, the controller-based memory (CBM) 328 may include three slave modules 632_1, 632_2, 632_3 and eight SRAM modules 680_1 to 680_8. FIG. 11 illustrates the controller-based memory (CBM) 328 as an example. According to an embodiment, the structure shown in FIG. 11 may be applied to other memory modules described in FIG. 2.

The eight SRAM modules 680_1 to 680_8 may correspond to the eight SRAM modules 660_1 to 660_8 described in FIG. 9. Each of the eight SRAM modules 680_1 to 680_8 may include one memory control logic and one memory control interface.

Referring to FIGS. 9 and 11, according to an embodiment, the number of slave modules corresponding to a same number of SRAM modules 660_1 to 660_8, 680_1 to 680_8 may vary. As the number of slave modules changes, a frequency of the clock used for driving the eight SRAM modules 660_1 to 660_8, 680_1 to 680_8 may vary. For example, in the embodiment described in FIG. 9, there are two slave modules, and the frequency of the clock used for driving the SRAM modules 660_1 to 660_8 is 450 MHz. On the other hand, in the embodiment described in FIG. 11, there are three slave modules, and the frequency of the clock used for driving the SRAM modules 680_1 to 680_8 is 600 MHZ.

As described above, the memory system or the memory subsystem according to an embodiment of the present disclosure may include two regions driven by two different clocks having different frequencies. For instance, the memory system or the memory subsystem can perform data input and output in an N-way interleaving way or scheme, when the M number of slave modules may be included in the memory system or the memory subsystem. A frequency of the clock used for driving the slave module included in the memory system or the memory subsystem may be referred to as A, and a frequency of the clock used for driving the memory module included in the memory system or the memory subsystem may be referred to as B. For achieving efficient operation of the memory system or the memory subsystem, the following equation could be satisfied.

$$B \geq 2 \times A \times ( M / N ) \qquad ( Equation )$$

Herein, B, A, M, and N are positive numbers. Through the above-mentioned equation, the frequency of the clock used for driving or operating the memory module can be determined based on an internal configuration of the memory system or the memory subsystem including a slave module (e.g., a memory module) designed to be driven with a clock in a specific frequency range. Referring to FIGS. 9 to 11, the internal configuration of the memory system or the memory subsystem may vary, and a planar size of the memory system or memory subsystem may vary in response to the required performance of the memory system or the memory subsystem.

Hereinafter, examples of a memory system that could be implemented as the system on chip (SoC) 300 will be described.

FIG. 12 illustrates a data processing system according to an embodiment of the present disclosure.

Referring to FIG. 12, the data processing system 100 may include a host 102 engaged or coupled with a memory system, such as memory system 110. For example, the host 102 and the memory system 110 can be coupled to each other via a data bus, a host cable and the like to perform data communication.

The memory system 110 may include a memory device 150 and a controller 130. The memory device 150 and the controller 130 in the memory system 110 may be considered components or elements physically separated from each other. The memory device 150 and the controller 130 may be connected via at least one data path. For example, the data path may include a channel and/or a way.

The memory device 150 can include plural memory chips 252 coupled to the controller 130 through plural channels CH0, CH1, . . . , CHn and ways W0, . . . , W_k. The memory chip 252 can include a plurality of memory planes or a plurality of memory dies. According to an embodiment, the memory plane may be considered a logical or a physical partition including at least one memory block, a driving circuit capable of controlling an array including a plurality of non-volatile memory cells, and a buffer that can temporarily store data inputted to, or outputted from, non-volatile memory cells. Each memory plane or each memory die can support an interleaving mode in which plural data input/output operations are performed in parallel or simultaneously. According to an embodiment, memory blocks included in each memory plane, or each memory die, included in the memory device 150 can be grouped to input/output plural data entries as a super memory block. An internal configuration of the memory device 150 shown in FIG. 12 may be changed based on operating performance of the memory system 110. An embodiment of the present disclosure may not be limited to the internal configuration described in FIG. 12.

According to an embodiment, the memory device 150 and the controller 130 may be components or elements functionally divided. Further, according to an embodiment, the memory device 150 and the controller 130 may be implemented with a single chip or a plurality of chips.

The controller 130 may perform a data input/output operation (such as a read operation, a program operation, an erase operation, etc.) in response to a request or a command input from an external device such as the host 102. For example, when the controller 130 performs a read operation in response to a read request input from an external device, data stored in a plurality of non-volatile memory cells included in the memory device 150 is transferred to the controller 130. Further, the controller 130 can independently perform an operation regardless of the request or the command input from the host 102. Regarding an operating state of the memory device 150, the controller 130 can perform an operation such as garbage collection (GC), wear leveling (WL), a bad block management (BBM) for checking whether a memory block is bad and handling a bad block.

Each memory chip 252 can include a plurality of memory blocks. The memory blocks may be understood to be a group of non-volatile memory cells in which data is removed together by a single erase operation. Although not illustrated, the memory block may include a page which is a group of non-volatile memory cells that store data together during a single program operation or output data together during a single read operation. For example, one memory block may include a plurality of pages. The memory device 150 may include a voltage supply circuit capable of supplying at least one voltage into the memory block. The voltage supply circuit may supply a read voltage Vrd, a program voltage Vprog, a pass voltage Vpass, or an erase voltage Vers into a non-volatile memory cell included in the memory block.

The host 102 interworking with the memory system 110, or the data processing system 110 including the memory system 110 and the host 102, is a mobility electronic device (such as a vehicle), a portable electronic device (such as a mobile phone, an MP3 player, a laptop computer, or the like), and a non-portable electronic device (such as a desktop computer, a game machine, a TV, a projector, or the like). The host 102 may provide interaction between the host 102 and a user using the data processing system 100 or the memory system 110 through at least one operating system (OS). The host 102 transmits a plurality of commands corresponding to a user's request to the memory system 110, and the memory system 110 performs data input/output operations corresponding to the plurality of commands (e.g., operations corresponding to the user's request).

Referring to FIG. 12, the controller 130 in a memory system operates along with the host 102 and the memory device 150. As illustrated, the controller 130 may have a layered structure including the host interface (HIL) 220, a flash translation layer (FTL) 240, and the memory interface layer or flash interface layer (FIL) 260.

The host interface layer (HIL) 220, the flash translation layer (FTL) 240, and the memory interface layer or flash interface layer (FIL) 260 described in FIG. 12 are illustrated as one embodiment. The host interface layer (HIL) 220, the flash translation layer (FTL) 240, and the flash interface layer (FIL) 260 may be implemented in various forms according to the operating performance of the memory system 110. According to an embodiment, the host interface layer (HIL) 220, the flash translation layer (FTL) 240, and the flash interface layer (FIL) 260 can perform operations through multi cores or processors having a pipelined structure included in the controller 130.

The host 102 and the memory system 110 may use a predetermined set of rules or procedures for data communication or a preset interface to transmit and receive data therebetween. Examples of sets of rules or procedures for data communication standards or interfaces supported by the host 102 and the memory system 110 for sending and receiving data include Universal Serial Bus (USB), Multi-Media Card (MMC), Parallel Advanced Technology Attachment (PATA), Small Computer System Interface (SCSI), Enhanced Small Disk Interface (ESDI), Integrated Drive Electronics (IDE), Peripheral Component Interconnect Express (PCIe or PCI-e), Serial-attached SCSI (SAS), Serial Advanced Technology Attachment (SATA), Mobile Industry Processor Interface (MIPI), and the like. According to an embodiment, the host 102 and the memory system 110 may be coupled to each other through a Universal Serial Bus (USB). The Universal Serial Bus (USB) is a highly scalable, hot-pluggable, plug-and-play serial interface that ensures cost-effective, standard connectivity to peripheral devices such as keyboards, mice, joysticks, printers, scanners, storage devices, modems, video conferencing cameras, and the like.

The memory system 110 may support the non-volatile memory express (NVMe) interface. The Non-volatile memory express (NVMe) is a type of interface based at least on a Peripheral Component Interconnect Express (PCIe) designed to increase performance and design flexibility of the host 102, servers, computing devices, and the like equipped with the non-volatile memory system 110. The PCIe can use a slot or a specific cable for connecting a computing device (e.g., host 102) and a peripheral device (e.g., memory system 110). For example, the PCIe can use a plurality of pins (e.g., 18 pins, 32 pins, 49 pins, or 82 pins) and at least one wire (e.g., x1, x4, x8, or x16) to achieve high speed data communication over several hundred MB per second. According to an embodiment, the PCIe scheme may achieve bandwidths of tens to hundreds of Giga bits per second.

A buffer manager 280 in the controller 130 can control the input/output of data or operation information in conjunction with the host interface layer (HIL) 220, the flash translation layer (FTL) 240, and the memory interface layer or flash interface layer (FIL) 260. To this end, the buffer manager 280 can set or establish various buffers, caches, or queues in a memory, and control data input/output of the buffers, the caches, or the queues, or data transmission between the buffers, the caches, or the queues in response to a request or a command generated by the host interface layer (HIL) 220, the flash translation layer (FTL) 240, and the memory interface layer or flash interface layer (FIL) 260. For example, the controller 130 may temporarily store read data provided from the memory device 150 in response to a request from the host 102 before providing the read data to the host 102. Also, the controller 130 may temporarily store write data provided from the host 102 in a memory before storing the write data in the memory device 150. When controlling operations such as a read operation, a program operation, and an erase operation performed within the memory device 150, the read data or the write data transmitted or generated between the controller 130 and the memory device 150 in the memory system 110 could be stored and managed in a buffer, a queue, etc. established in the memory by the buffer manager 280. Besides the read data or the write data, the buffer manager 280 can store signal or information (e.g., map data, a read command, a program command, or etc. which is used for performing operations such as programming and reading data between the host 102 and the memory device 150) in the buffer, the cache, the queue, etc. established in the memory. The buffer manager 280 can set, or manage, a command queue, a program memory, a data memory, a write buffer/cache, a read buffer/cache, a data buffer/cache, a map buffer/cache, and etc.

The host interface layer (HIL) 220 may handle commands, data, and the like transmitted from the host 102. By way of example but not limitation, the host interface layer 220 may include a command queue manager 222 and an event queue manager 224. The command queue manager 222 may sequentially store the commands, the data, and the like received from the host 102 in a command queue, and output them to the event queue manager 224, for example, in an order in which they are stored in the command queue manager 222. The event queue manager 224 may sequentially transmit events for processing the commands, the data, and the like received from the command queue. According to an embodiment, the event queue manager 224 may classify, manage, or adjust the commands, the data, and the like received from the command queue. Further, according to an embodiment, the host interface layer 220 can include an encryption manager 226 configured to encrypt a response or output data to be transmitted to the host 102 or to decrypt an encrypted portion in the command or data transmitted from the host 102.

A plurality of commands or data of the same characteristic may be transmitted from the host 102, or a plurality of commands and data of different characteristics may be transmitted to the memory system 110 after being mixed or jumbled by the host 102. For example, a plurality of commands for reading data, i.e., read commands, may be delivered, or commands for reading data, i.e., a read command, and a command for programming/writing data, i.e., a write command, may be alternately transmitted to the memory system 110. The command queue manager 222 of the host interface layer 220 may sequentially store commands, data, and the like, which are transmitted from the host 102, in the command queue. Thereafter, the host interface layer 220 may estimate or predict what type of internal operations the controller 130 will perform according to the characteristics of the commands, the data, and the like, which have been transmitted from the host 102. The host interface layer 220 may determine a processing order and a priority of commands, data and the like based on their characteristics. According to the characteristics of the commands, the data, and the like transmitted from the host 102, the event queue manager 224 in the host interface layer 220 is configured to receive an event, which should be processed or handled internally within the memory system 110 or the controller 130 according to the commands, the data, and the like input from the host 102, from the buffer manager 280. Then, the event queue manager 224 can transfer the event including the commands, the data, and the like into the flash translation layer (FTL) 240.

According to an embodiment, the flash translation layer (FTL) 240 may include a host request manager (HRM) 242, a map manager (MM) 244, a state manager 246, and a block manager 248. Further, according to an embodiment, the flash translation layer (FTL) 240 may implement a multi-thread scheme to perform data input/output (I/O) operations. A multi-thread FTL may be implemented through a multi-core processor using multi-thread included in the controller 130. For example, the host request manager (HRM) 242 may manage the events transmitted from the event queue. The map manager (MM) 244 may handle or control map data. The state manager 246 may perform an operation such as garbage collection (GC) or wear leveling (WL), after checking an operating state of the memory device 150. The block manager 248 may execute commands or instructions onto a block in the memory device 150.

The host request manager (HRM) 242 may use the map manager (MM) 244 and the block manager 248 to handle or process requests according to read and program commands and events which are delivered from the host interface layer 220. The host request manager (HRM) 242 may send an inquiry request to the map manager (MM) 244 to determine a physical address corresponding to a logical address which is entered with the events. The host request manager (HRM) 242 may send a read request with the physical address to the memory interface layer 260 to process the read request, i.e., handle the events. In one embodiment, the host request manager (HRM) 242 may send a program request (or a write request) to the block manager 248 to program data to a specific empty page storing no data in the memory device 150, and then may transmit a map update request corresponding to the program request to the map manager (MM) 244 in order to update an item relevant to the programmed data in information of mapping the logical and physical addresses to each other.

The block manager 248 may convert a program request delivered from the host request manager (HRM) 242, the map manager (MM) 244, and/or the state manager 246 into a flash program request used for the memory device 150, to manage flash blocks in the memory device 150. To maximize or enhance program or write performance of the memory system 110, the block manager 248 may collect program requests and send flash program requests for multiple-plane and one-shot program operations to the memory interface layer 260. In an embodiment, the block manager 248 sends several flash program requests to the memory interface layer 260 to enhance or maximize parallel processing of a multi-channel and multi-directional flash controller.

In an embodiment, the block manager 248 may manage blocks in the memory device 150 according to the number of valid pages, select and erase blocks having no valid pages when a free block is needed and select a block including the least number of valid pages when it is determined that garbage collection is to be performed. The state manager 246 may perform garbage collection to move valid data stored in the selected block to an empty block and erase data stored in the selected block so that the memory device 150 may have enough free blocks (i.e., empty blocks with no data).

When the block manager 248 provides information regarding a block to be erased to the state manager 246, the state manager 246 may check all flash pages of the block to be erased to determine whether each page of the block is valid. For example, to determine validity of each page, the state manager 246 may identify a logical address recorded in an out-of-band (OOB) area of each page. To determine whether each page is valid, the state manager 246 may compare a physical address of the page with a physical address mapped to a logical address obtained from an inquiry request. The state manager 246 sends a program request to the block manager 248 for each valid page. A map table may be updated by the map manager 244 when a program operation is complete.

The map manager 244 may manage map data, e.g., a logical-physical map table. The map manager 244 may process various requests, for example, queries, updates, and the like, which are generated by the host request manager (HRM) 242 or the state manager 246. The map manager 244 may store the entire map table in the memory device 150, e.g., a flash/non-volatile memory, and cache mapping entries according to the storage capacity of the memory 144. When a map cache miss occurs while processing inquiry or update requests, the map manager 244 may send a read request to the memory interface layer 260 to load a relevant map table stored in the memory device 150. When the number of dirty cache blocks in the map manager 244 exceeds a certain threshold value, a program request may be sent to the block manager 246, so that a clean cache block is made and a dirty map table may be stored in the memory device 150.

When garbage collection is performed, the state manager 246 copies valid page(s) into a free block, and the host request manager (HRM) 242 may program the latest version of the data for the same logical address of the page and concurrently issue an update request. When the state manager 246 requests the map update in a state in which the copying of the valid page(s) is not completed normally, the map manager 244 may not perform the map table update. This is because the map request is issued with old physical information when the state manger 246 requests a map update and a valid page copy is completed later. The map manager 244 may perform a map update operation to ensure accuracy when, or only if, the latest map table still points to the old physical address.

The memory interface layer or flash interface layer (FIL) 260 may exchange data, commands, state information, and the like, with a plurality of memory chips 252 in the memory device 150 through a data communication method. According to an embodiment, the memory interface layer 260 may include a status check schedule manager 262 and a data path manager 264. The status check schedule manager 262 can check and determine the operating state regarding the plurality of memory chips 252 coupled to the controller 130, the operating state regarding a plurality of channels CH0, CH1, . . . , CHn and the plurality of ways W0, . . . , W_k, and the like. The transmission and reception of data or commands can be scheduled in response to the operating states regarding the plurality of memory chips 252 and the plurality of channels CH0, CH1, . . . , CHn. The data path manager 264 can control the transmission and reception of data, commands, etc. through the plurality of channels CH0, CH1, . . . , CHn and ways W0, . . . , W_k based on the information transmitted from the status check schedule manager 262. According to an embodiment, the data path manager 264 may include a plurality of transceivers, each transceiver corresponding to each of the plurality of channels CH0, CH1, . . . , CHn. Further, according to an embodiment, the status check schedule manager 262 and the data path manager 264 included in the memory interface layer 260 could be implemented as, or engaged with, a memory control sequence generator.

According to an embodiment, the memory interface layer 260 may further include ECC (error correction code) circuitry 266 configured to perform error checking and correction of data transferred between the controller 130 and the memory device 150. The ECC unit 266 may be implemented as a separate module, circuit, or firmware in the controller 130, but may also be implemented in each memory chip 252 included in the memory device 150 according to an embodiment. The ECC circuitry 266 may include a program, a circuit, a module, a system, or an apparatus for detecting and correcting an error bit of data processed by the memory device 150.

For finding and correcting any error of data transferred from the memory device 150, the ECC circuitry 266 can include an error correction code (ECC) encoder and an ECC decoder. The ECC encoder may perform error correction encoding of data to be programmed in the memory device 150 to generate encoded data into which a parity bit is added and store the encoded data in the memory device 150. The ECC decoder can detect and correct error bits contained in the data read from the memory device 150 when the controller 130 reads the data stored in the memory device 150. For example, after performing error correction decoding on the data read from the memory device 150, the ECC circuitry 266 can determine whether the error correction decoding has succeeded or not, and outputs an instruction signal, e.g., a correction success signal or a correction fail signal, based on a result of the error correction decoding. The ECC circuitry 266 may use a parity bit, which has been generated during the ECC encoding process for the data stored in the memory device 150, to correct the error bits of the read data entries. When the number of the error bits is greater than or equal to the number of correctable error bits, the ECC circuitry 138 may not correct the error bits and instead may output the correction fail signal indicating failure in correcting the error bits.

According to an embodiment, the error correction circuitry 138 may perform an error correction operation based on a coded modulation such as a low density parity check (LDPC) code, a Bose-Chaudhuri-Hocquenghem (BCH) code, a turbo code, a Reed-Solomon (RS) code, a convolution code, a recursive systematic code (RSC), a trellis-coded modulation (TCM), a Block coded modulation (BCM), or the like. The error correction circuitry 138 may include all circuits, modules, systems, and/or devices for performing the error correction operation based on at least one of the above-described codes.

For example, the encoder in the ECC circuitry 266 may generate a codeword that is a unit of ECC-applied data. A codeword of length n bits may include k bits of user data and (n-k) bits of parity. A code rate may be calculated as (k/n). The higher the code rate, the more user data that can be stored in a given codeword. When the length of the codeword is longer and the code rate is smaller, the error correction capability of the ECC circuitry 266 could be improved. In addition, the ECC circuitry 266 performs decoding using information read from the channels CH0, CH1, . . . , CHn. The decoder in the ECC circuitry 266 can be classified into a hard decision decoder and a soft decision decoder according to how many bits represent the information to be decoded. A hard decision decoder performs decoding with a memory cell output information expressed in 1 bit, and the 1-bit information used at this time is called hard decision information. A soft decision decoder uses more accurate memory cell output information composed of 2 bits or more, and this information is called soft decision information. The ECC circuitry 266 may correct errors included in data using the hard decision information or the soft decision information.

According to an embodiment, to increase the error correction capability, the ECC circuitry 266 may use a concatenated code using two or more codes. In addition, the ECC circuitry 266 may use a product code that divides one codeword into several rows and columns and applies a different relatively short ECC to each row and column.

In accordance with an embodiment, a manager included in the host interface layer 220, the flash translation layer (FTL) 240, and the memory interface layer or flash interface layer (FIL) 260 could be implemented with a general processor, an accelerator, a dedicated processor, a co-processor, a multi-core processor, or the like. According to an embodiment, the manager can be implemented with firmware working with a processor.

According to an embodiment, the memory device 150 is embodied as a non-volatile memory such as a flash memory, for example, a Read Only Memory (ROM), a Mask ROM (MROM), a Programmable ROM (PROM), an Erasable ROM (EPROM), an Electrically Erasable ROM (EEPROM), a Magnetic (MRAM), a NAND flash memory, a NOR flash memory, or the like. In another embodiment, the memory device 150 may be implemented by at least one of a phase change random access memory (PCRAM), a Resistive Random Access Memory (ReRAM), a ferroelectrics random access memory (FRAM), a transfer torque random access memory (STT-RAM), and a spin transfer torque magnetic random access memory (STT-MRAM), or the like.

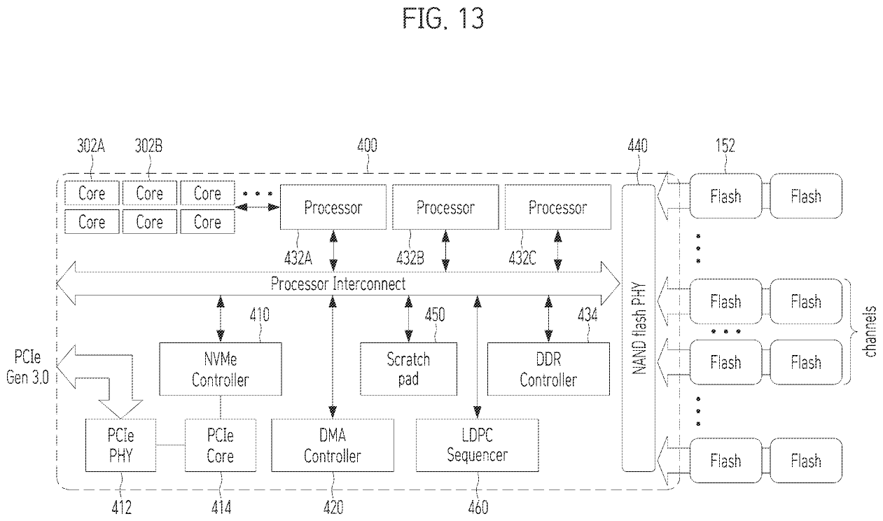

FIG. 13 illustrates a data storage system according to an embodiment of the present disclosure. FIG. 13 shows a memory system including multiple cores or multiple processors, which is an example of a data storage system. The memory system may support the Non-Volatile Memory Express (NVMe) protocol.

The NVMe is a type of transfer protocol designed for a solid-state memory that could operate much faster than a conventional hard drive. The NVMe can support higher input/output operations per second (IOPS) and lower latency, resulting in faster data transfer speeds and improved overall performance of the data storage system. Unlike SATA which has been designed for a hard drive, the NVMe can leverage the parallelism of solid-state storage to enable more efficient use of multiple queues and processors (e.g., CPUs). The NVMe is designed to allow hosts to use many threads to achieve higher bandwidth. The NVMe can allow the full level of parallelism offered by SSDs to be fully exploited. However, because of limited firmware scalability, limited computational power, and high hardware contention within SSDs, the memory system might not process a large number of I/O requests in parallel.

Referring to FIG. 13, the host, which is an external device, can be coupled to the memory system through a plurality of PCIe Gen 3.0 lanes, a PCIe physical layer 412, and a PCIe core 414. A controller 400 may include three embedded processors 432A, 432B, 432C, each using two cores 302A, 302B. Herein, the plurality of cores 302A, 302B or the plurality of embedded processors 432A, 432B, 432C may have a pipeline structure.

The plurality of embedded processors 432A, 432B, 432C may be coupled to the internal DRAM controller 434 through a processor interconnect. The controller 400 further includes a Low Density Parity-Check (LDPC) sequencer 460, a Direct Memory Access (DMA) engine 420, a scratch pad memory 450 for metadata management, and an NVMe controller 410. Components within the controller 400 may be coupled to a plurality of channels connected to a plurality of memory packages 152 through a flash physical layer 440. The plurality of memory packages 152 may correspond to the plurality of memory chips 252 described in FIG. 12.

According to an embodiment, the NVMe controller 410 included in the controller 400 is a type of storage controller designed for use with solid state drives (SSDs) that use an NVMe interface. The NVMe controller 410 may manage data transfer between the SSD and the computer CPU as well as other functions such as error correction, wear leveling, and power management. The NVMe controller 410 may use a simplified, low-overhead protocol to support fast data transfer rates.

According to an embodiment, a scratch pad memory 450 may be a storage area set by the NVMe controller 410 to temporarily store data. The scratch pad memory 450 may be used to store data waiting to be written to a plurality of memory packages 152. The scratch pad memory 450 can also be used as a buffer to speed up the writing process, typically with a small amount of Dynamic Random Access Memory (DRAM) or Static Random Access Memory (SRAM). When a write command is executed, data may first be written to the scratch pad memory 450 and then transferred to the plurality of memory packages 152 in larger blocks. The scratch pad memory 450 may be used as a temporary memory buffer to help optimize the write performance of the plurality of memory packages 152. The scratch pad memory 450 may serve as intermediate storage of data before the data is written to non-volatile memory cells.

The Direct Memory Access (DMA) engine 420 included in the controller 400 is a component that transfers data between the NVMe controller 410 and a host memory in the host system without involving a host's processor. The DMA engine 420 can support the NVMe controller 410 to directly read or write data from or to the host memory without intervention of the host's processor. According to an embodiment, the DMA engine 420 may achieve or support high-speed data transfer between a host and an NVMe device, using a DMA descriptor that includes information regarding data transfer such as a buffer address, a transfer length, and other control information.

The Low Density Parity Check (LDPC) sequencer 460 in the controller 400 is a component that performs error correction on data stored in the plurality of memory packages 152. Herein, an LDPC code is a type of error correction code commonly used in a NAND flash memory to reduce a bit error rate. The LDPC sequencer 460 may be designed to immediately process encoding and decoding of LDPC codes when reading and writing data from and to the NAND flash memory. According to an embodiment, the LDPC sequencer 460 may divide data into plural blocks, encode each block using an LDPC code, and store the encoded data in the plurality of memory packages 152. Thereafter, when reading the encoded data from the plurality of memory packages 152, the LDPC sequencer 460 can decode the encoded data based on the LDPC code and correct errors that may have occurred during a write or read operation. The LDPC sequencer 460 may correspond to the ECC module 266 described in FIG. 12.

In addition, although FIGS. 12 and 13 illustrate an example of a memory system including a memory device 150 or a plurality of memory packages 152 capable of storing data, the data storage system according to an embodiment of the present disclosure may not be limited to the memory system described in FIGS. 12 and 13. For example, the memory device 150, the plurality of memory packages 152, or the data storage device controlled by the controllers 130, 400 may include volatile or non-volatile memory devices. In FIG. 13, it is described that the controller 400 can perform data communication with the host 102 externally placed from the memory system (see FIG. 12) through an NVM Express (NVMe) interface and a PCI Express (PCIe). In an embodiment, the controller 400 may perform data communication with at least one host through a protocol such as a Compute Express Link (CXL).

Additionally, according to an embodiment, an apparatus and method for performing distributed processing or allocation/reallocation of the plurality of instructions in a controller including multi processors of the pipelined structure according to an embodiment of the present disclosure can be applicable to a data processing system including a plurality of memory systems or a plurality of data storage devices. For example, a Memory Pool System (MPS) is a very general, adaptable, flexible, reliable and efficient memory management system where a memory pool such as a logical partition of primary memory or storage reserved for processing a task or group of tasks could be used to control or manage a storage device coupled to the controller. The controller including multi processors in the pipelined structure can control data and program transfer to the memory pool controlled or managed by the memory pool system (MPS).

As above described, a system-on-chip (SoC) according to an embodiment of the present disclosure can reduce a planer area of the memory device while avoiding or reducing a bottleneck even if an operating speed of the memory device is slower than that of the system-on-chip (SoC).

Further, a memory device or a memory system according to an embodiment of the present disclosure can improve or enhance operation performance of a memory controller coupled to the memory device, thereby improving overall operation performance, e.g., I/O throughput, of the memory device or the memory system.

The methods, processes, and/or operations described herein may be performed by code or instructions to be executed by a computer, processor, controller, or other signal processing device. The computer, processor, controller, or other signal processing device may be those described herein or one in addition to the elements described herein. Because the algorithms that form the basis of the methods or operations of the computer, processor, controller, or other signal processing device, are described in detail, the code or instructions for implementing the operations of the method embodiments may transform the computer, processor, controller, or other signal processing device into a special-purpose processor for performing the methods herein.

Also, another embodiment may include a computer-readable medium, e.g., a non-transitory computer-readable medium, for storing the code or instructions described above. The computer-readable medium may be a volatile or non-volatile memory or other storage device, which may be removably or fixedly coupled to the computer, processor, controller, or other signal processing device which is to execute the code or instructions for performing the method embodiments or operations of the apparatus embodiments herein.

The controllers, processors, control circuitry, devices, modules, units, multiplexers, generators, logic, interfaces, decoders, drivers, and other signal generating and signal processing features of the embodiments disclosed herein may be implemented, for example, in non-transitory logic that may include hardware, software, or both. When implemented at least partially in hardware, the controllers, processors, control circuitry, devices, modules, units, multiplexers, generators, logic, interfaces, decoders, drivers, and other signal generating and signal processing features may be, for example, any of a variety of integrated circuits including but not limited to an application-specific integrated circuit, a field-programmable gate array, a combination of logic gates, a system-on-chip, a microprocessor, or another type of processing or control circuit.

When implemented at least partially in software, the controllers, processors, control circuitry, devices, modules, units, multiplexers, generators, logic, interfaces, decoders, drivers, and other signal generating and signal processing features may include, for example, a memory or other storage device for storing code or instructions to be executed, for example, by a computer, processor, microprocessor, controller, or other signal processing device. The computer, processor, microprocessor, controller, or other signal processing device may be those described herein or one in addition to the elements described herein. Because the algorithms that form the basis of the methods or operations of the computer, processor, microprocessor, controller, or other signal processing device, are described in detail, the code or instructions for implementing the operations of the method embodiments may transform the computer, processor, controller, or other signal processing device into a special-purpose processor for performing the methods described herein.

While the present teachings have been illustrated and described with respect to the specific embodiments, it will be apparent to those skilled in the art in light of the present disclosure that various changes and modifications may be made without departing from the spirit and scope of the disclosure as defined in the following claims. Furthermore, the embodiments may be combined to form additional embodiments.

What is claimed is:

1. A system-on-chip comprising:
plural components configured to perform separate functions, separate calculations or separate operations; and
a bus interface configured to support data communication between the plural components according to a point-to-point interconnect protocol,
wherein at least one component of the plural components is operatively engaged with a memory device, and
wherein the at least one component comprises:
plural memory interfaces configured to access the memory device in an n-way interleaving way, ‘n’ being a positive integer equal to or greater than 2; and
at least one slave intellectual property (IP) core configured to distribute and transmit, to the plural memory interfaces, plural commands that are input through the bus interface.

2. The system-on-chip according to claim 1, wherein:
the at least one slave IP core is configured to operate according to a first clock,
the plural memory interfaces are configured to operate according to a second clock, and
the first and second clocks respectively have first and second frequencies different from each other.

3. The system-on-chip according to claim 2, wherein the first frequency is higher than the second frequency.

4. The system-on-chip according to claim 3, wherein a ratio of the first frequency to the second frequency depends on a ratio of a first number of the plural memory interfaces to a second number of the at least one slave IP core.

5. The system-on-chip according to claim 4, wherein the first number is four times the second number.

6. The system-on-chip according to claim 4, wherein the second frequency is greater than or equal to a value obtained by:
multiplying the first frequency by 2 to obtain a first multiplication value,
multiplying the first multiplication value by the second number to obtain a second multiplication value, and
dividing the second multiplication value by the first number.

7. The system-on-chip according to claim 1, wherein the at least one slave IP core comprises:
a write module configured to sequentially transmit, to the plural memory interfaces, write commands and write data input through the bus interface and configured to output, to the plural components, responses corresponding to the write commands; and
a read module configured to sequentially transmit, to the plural memory interfaces, read commands input through the bus interface and configured to output, to the plural components, read data corresponding to the read commands.

8. The system-on-chip according to claim 7, wherein a first number of the plural memory interfaces is twice a second number of the at least one slave IP core.

9. The system-on-chip according to claim 7, wherein the at least one slave IP core further comprises a gating logic configured to perform at least one operation of:
distributing and transferring, to the plural memory interfaces, the write commands and the write data transmitted from the write module, and
collecting the read data transmitted from the plural memory interfaces to transfer the read data to the read module.

10. The system-on-chip according to claim 9, wherein a first number of the plural memory interfaces is four times a second number of the at least one slave IP core.

11. The system-on-chip according to claim 9, wherein the gating logic comprises:
a first arbitration circuit configured to parallelly process the write commands and the write data;
a first switching circuit configured to collect and transmit the responses to the plural components;
a second arbitration circuit configured to parallelly process the read commands; and
a second switching circuit configured to collect and transmit the read data to the read module.

12. A system-on-chip comprising:
plural components configured to perform separate functions, separate calculations or separate operations; and
a bus interface configured to support data communication between the plural components according to a point-to-point interconnect protocol,
wherein at least one component of the plural components comprises:
a first area comprising plural memory cells for storing data; and
a second area comprising a logic or a circuit configured to input or output the data to or from the first area, and
wherein a second planar size of the second area is 50 to 65 times a first planar size of the first area.

13. The system-on-chip according to claim 12, wherein:
the plural memory cells are arranged in rows and columns, and
each of the plural memory cells is a Static Random Access Memory (SRAM) cell.

14. The system-on-chip according to claim 13, wherein the logic or the circuit comprises:
plural memory interfaces configured to access the plural memory cells in an n-way interleaving way, ‘n’ being a positive integer equal to or greater than 2; and
at least one slave intellectual property (IP) core configured to distribute and transmit, to the plural memory interfaces, plural commands that are input through the bus interface.

15. The system-on-chip according to claim 14, wherein:
the at least one slave IP core is configured to operate according to a first clock,
the plural memory interfaces are configured to operate according to a second clock, and
the first and second clocks respectively have first and second frequencies different from each other.

16. The system-on-chip according to claim 15, wherein:
a number of the at least one slave IP core is m, where m is a positive integer, and
the second frequency is greater than or equal to a value obtained by:
multiplying the first frequency by 2 to obtain a multiplication value, and
multiplying the multiplication value by m/n.

17. A memory system comprising:
n number of memories, ‘n’ being a positive integer equal to or greater than 2;
at least one slave intellectual property (IP) circuit coupled to a bus interface and configured to receive commands; and
a gating logic configured to distribute and transmit the commands input from the at least one slave IP circuit to the n number of memories for accessing the n number of memories in an n-way interleaving manner.

18. The memory system according to claim 17, wherein each of the n number of memories comprises:
plural memory cells for storing data;
a memory interface configured to access the plural memory cells; and
a data path circuit coupled to the memory interface.

19. The memory system according to claim 17,
wherein each of the plural memory cells is a Static Random Access Memory (SRAM) cell, and
wherein a planar size occupied by the plural memory cells accounts for 98 to 98.5% of a total planar size of the memory system.

20. The memory system according to claim 17, wherein:
the at least one slave IP core and the gating logic are each configured to operate according to a first clock,
the n number of memories having a same data storage capacity are configured to operate according to a second clock, and
the first and second clocks respectively have first and second frequencies different from each other.
